(19) United States
(12) Patent Application Publication
(10) Pub. No.: US 2026/0077911 A1
(43) Pub. Date: Mar. 19, 2026

(54) Smart Pet Waste Collection Bags

(71) Applicant: Victoria Zetian Li, Glen Mills, PA (US)

(72) Inventor: Victoria Zetian Li, Glen Mills, PA (US)

(21) Appl. No.: 18/885,650

(22) Filed: Sep. 14, 2024

(51) Int. Cl. B65D 33/00; B65F 1/00; E01H 1/00

(52) U.S. Cl. CPC B65D 33/004; B65D 33/002; B65F 1/0006; E01H 1/006; B65F 2240/136

(57) ABSTRACT

Pet waste collection bags, which can visually remind a user of the low supply of bags, are provided. The invention utilizes different color(s) for the last few bags in a roll of pet waste collection bags to notify the user when the last few bags are left in the pet waste collection bag dispenser. When the user sees the bag color change, they know it is time to insert a new roll of pet waste collection bags into the bag dispenser.

### BACKGROUND OF THE INVENTION

The present invention relates to bags for picking up the defecation of pets, such as dogs, and, more specifically, to bags that visually warn the user when they are running out of bags and need to have a new roll of bags in the bag dispenser.

Pets, particularly dogs, often defecate while their owners are taking them for a walk. Most municipalities and communities require the waste to be picked up and removed. Dog owners often face the inconvenience of running out of waste disposal bags while walking their dogs. This issue can arise if they forget to check the bag supply before leaving home or if their dog needs to relieve itself multiple times during the walk. The latter is particularly common, as it's not always convenient to keep track of how many bags remain in the dispenser.

As can be seen, there is a need for specially designed pet waste collection bags that can remind the pet owner when a new roll of bags needs to be prepared to replace the old roll in the bag dispenser.

### SUMMARY OF THE INVENTION

In one aspect of the present invention, a roll of pet waste collection bags comprises two colors of bags with a majority of the bags in one color and a few bags near the end in another color, serving as a warning that the bag supply is low.

In another aspect of the present invention, a roll of pet waste collection bags comprises three colors of bags: the majority of the bags in one color and a few bags near the end in two other colors, indicating the low bag supply with one color serving as a reminder and the other as a warning.

The present invention enhances user convenience by visually alerting them to low levels of pet waste collection bags through an alarming color change in the bags.

### BRIEF DESCRIPTION OF DRAWINGS

FIG. 1 is a view of the two-color bag design: a majority of bags in one color and a few (e.g., three red bags) near the end in another color, serving as a warning of the low bag supply.

FIG. 2 is a view of the three-color bag design: a majority of bags in one color and a few bags near the end in two other colors, indicating the low bag supply with one color as a reminder (e.g., three yellow bags) and the other as a warning (e.g., two red bags).

### DETAILED DESCRIPTION OF THE INVENTION

The following detailed description is of the best currently contemplated modes of carrying out exemplary embodiments of the invention. The description is not to be taken in a limiting sense but is provided merely for the purpose of illustrating the general principles of the invention since the scope of the invention is best defined by the appended claims.

Broadly, an embodiment of the present invention provides color-coded bags to visually alert the user of the low supply of pet waste collection bags. The color-coded alerting bags are placed close to the end of a roll of pet waste collection bags, and the alerting bags are different in color from the majority of the bags in the roll.

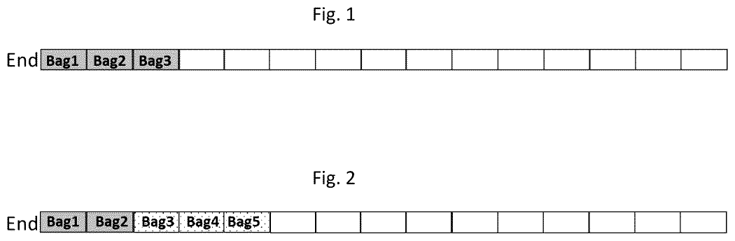

Referring to FIG. 1, the color of the alerting bags can be any alarming color, such as red. In the example shown in FIG. 1, the last three bags (Bag 1, Bag 2, and Bag 3) are red, contrasting with the majority of the bags, indicating that the supply is very low.

Referring to FIG. 2, the alerting bags can have two colors. One color, such as yellow, serves as a reminder, and the other color, such as red, serves as a warning. In the example shown in FIG. 2, the last two bags (Bag 1 and Bag 2) are in a warning color, such as red, to provide a strong alert that the user is about to run out of bags, while the preceding three bags (Bag 3, Bag 4, and Bag 5) are in a reminder color, such as yellow, to indicate that the supply is low.

The number of the alerting bags can be as few as one. Preferably, the number of the alerting bags does not exceed five.

Throughout of this application, the term “majority” means more than 50% and the term “few” means no more than one-third.

1. A roll of pet waste collection bags comprising a majority of bags in one color and a few bags near an end of the roll in at least one different color.

2. The roll of pet waste collection bags of claim 1, wherein the bags at the end of the roll are in a single different color.

3. The roll of pet waste collection bags of claim 2, wherein the single different color is red.

4. The roll of pet waste collection bags of claim 1, wherein the bags at the end of the roll are in two different colors with a first different color followed by a second different color.

5. The roll of pet waste collection bags of claim 4, wherein the first different color is yellow, and the second different color is red.
